(19) United States
(12) Patent Application Publication
(10) Pub. No.: US 2015/0032596 A1
(43) Pub. Date: Jan. 29, 2015

(54) SYSTEM AND METHOD FOR MATCHLESS POST-TRADE PROCESSING

(71) Applicant: FIDESSA CORPORATION, London (GB)

(72) Inventors: Paul Nokes, London (GB); Paul Martin, London (GB); Simon Halson, London (GB); Paul Whenham, London (GB); David Pearson, London (GB)

(73) Assignee: Fidessa Corporation, London (GB)

(21) Appl. No.: 14/446,217

(22) Filed: Jul. 29, 2014

Related U.S. Application Data
(63) Continuation of application No. PCT/US2013/024048, filed on Jan. 31, 2013.
(60) Provisional application No. 61/593,592, filed on Feb. 1, 2012.
(60) Provisional application No. 61/702,887, filed on Sep. 19, 2012.

(51) Int. Cl. G06Q 40/00

(52) U.S. Cl. CPC G06Q 40/04
USPC 705/37

(57) ABSTRACT

Techniques for managing the trading of financial instruments using a central utility including one or more storage devices for storing a set of rules for confirmation in the trading of financial instruments. One or more processors are operatively coupled to the storage devices and one or more transmitters and receivers and configured to receive trade messages sent over a network between a buy-side party and a sell-side party, validate the trade messages between the parties, and generate an electronic file including an enriched trade report based on at least the trade messages, the set of rules, and allocation information including one or more trades. The electronic file including the enriched trade report is transmitted over the network to at least one of the buy-side party and the sell-side party.

### CROSS-REFERENCE TO RELATED APPLICATIONS

This application is a continuation of International Application PCT/US2013/024048, filed Jan. 31, 2013, which claims priority to U.S. Provisional Application Ser. No. 61/593,592, filed Feb. 1, 2012, and U.S. Provisional Application Ser. No. 61/702,887, filed on Sep. 19, 2012, each of which is incorporated herein by reference in its entirety and from each of which priority is claimed.

### BACKGROUND

The disclosed subject matter relates to techniques for the management of the trading of financial instruments, and more particularly to techniques for enabling a centralized enrichment service for client trade allocation and confirmation in the trading of financial instruments.

In the trading of financial instruments, including, e.g., equities, options, futures, derivatives, or the like, parties conventionally initiate a transaction and agree to settle the transaction at a later time. For example, a typical transaction can occur as follows: a buy-side party (e.g., an investment manager) can issue a trade instruction (which can be, e.g., a buy order or a sell order) to a sell-side party (e.g., a broker-dealer). The sell-side party can execute the trade and send a “notice of execution” to the buy-side party. The buy-side party can then send details of the trade, including allocation instruction indicating how to allocate the trade among the accounts of the buy-side party, to the sell-side party, who can either accept or reject the trade details and allocations. An acceptance or rejection can then be transmitted back to the buy-side party. If the trade details and allocations are acceptable, the sell-side party can provide additional information related to the trade and transmit a confirmation to the buy-side party. The buy-side party can then validate the information in the trade confirmation and respond with an affirmation. At this point, both the buy-side party and the sell-side party can submit the trade to settling agents, e.g., with standard settlement instructions (“SSI”) who can exchange the cash and financial instruments on a settlement date.

In connection with the trading of financial instruments, middle office workflow can be built around the transfer of necessary information to drive the settlement process between buy-side and sell-side parties, including, e.g., market charges, broker commission, and standard settlement instructions (SSI). The information flow associated with ordering and executing trades can be increasingly complex as electronic models have been adopted alongside traditional manual processing using telephone, email, and facsimile. In some circumstances, this complexity is exacerbated by the need to match allocations (e.g., on the sub-account level) by a sell-side party upon receipt from a buy-side party. For example, conventional post-trade confirmation has typically been accomplished by independent derivation of characteristics of the trade (that is, the buy-side and the sell-side independently calculate the characteristics, such as applicable commission and taxes), and then by matching these independently derived characteristics after the trade, either manually or with the aid of an automation device. Such confirmation can be inefficient, time consuming, and can lead to errors.

Accordingly, there is a need for improved techniques for trade allocation and confirmation.

### SUMMARY

The disclosed subject matter provides techniques for the management of the trading of financial instruments, and more particularly to techniques for enabling a centralized enrichment service for client trade allocation and confirmation in the trading of financial instruments.

In one aspect of the disclosed subject matter, a system for managing the trading of financial instruments using a central utility can include one or more storage devices having stored therein a set of rules for confirmation in the trading of the financial instruments. The set of rules can be mutually agreed upon by a buy-side party and a sell-side party. One or more transmitters and receivers can be communicatively coupled to a network. One or more processors can be operatively coupled to the one or more storage devices and the one or more transmitters and receivers, and can be configured to receive trade messages sent over the network between the buy-side party and the sell-side party. At least one of the trade messages can include allocation information from the buy-side party including one or more allocated trades. The one or more processors can be configured to validate the trade messages between the buy-side party and the sell-side party and generate an electronic file including an enriched trade report based on at least the trade messages, the set of rules, and the allocation information. The electronic file can be transmitted over the network to the buy-side party and the sell-side party.

In one embodiment, the central utility can include one or more of a server, a cluster of servers, a distributed computing system, or a cloud based computing system. The one or more storage devices can include one or more memory devices, databases, or computer readable media. The one or more transmitters and receivers can include one or more network interface cards adapted to communicate via the network.

In one embodiment, the trade messages can include Financial Information eXchange (FIX) messages. The trade messages can include a client order instruction message including an order ID parameter, a client ID parameter, and an order volume parameter. Additionally or alternatively, the trade messages can include an execution record message including an order ID parameter, an execution ID parameter, an executed volume parameter, and an executed price parameter. Additionally or alternatively, the trade message can include an allocation record message include an order ID parameter, a fund ID parameter, an allocation volume parameter, and an allocation value parameter.

In one embodiment, the set of rules can include market charge rules to calculate appropriate market charges for each allocated trade. The enriched trade report included in the generated electronic file can include the appropriate market charges. The receiver can be configured to receive, over the network, the market charge rules from the sell-side party and receive, over the network, and approval message corresponding to the market charge rules from the buy-side party. Upon receipt of the approval message, the market charge rules can be stored in the one or more storage devices.

In one embodiment, the set of rules can include commission rules to calculate appropriate commission amount for each allocated trade. The enriched trade report included in the generated electronic file can include the appropriate commission amount. The receiver can be configured to receive, over the network, the commission rules from the sell-side party and receive, over the network, an approval message corresponding to the commission rules from the buy-side party. Upon receipt of the approval message, the commission rules can be stored in the one or more storage devices.

In one embodiment, the set of rules can include standard settlement instruction rules to generate standard settlement instructions for the buy-side party and the sell-side party for each allocated trade. The enriched trade report included in the generated electronic file can include the standard settlement instructions for the buy-side party and the sell-side party. The receiver can be configured to receive, over the network, the standard settlement instruction rules for the buy-side party and the sell-side party. The transmitter can be configured to transmit a notification message to the buy-side party upon receipt of the standard settlement instruction rules for the sell-side party and transmit a notification message to the sell-side party upon receipt of the standard settlement instruction rules for the buy-side party.

In one embodiment, the one or more storage devices can be configured to store the electronic file including the enriched trade report, for each allocated trade, for a predetermined period of time.

In another aspect of the disclosed subject matter, a method for managing the trading of financial instruments using a central utility including one or more storage devices, one or more transmitters and receivers communicatively coupled to a network, and one or more processors operatively coupled to the one or more storage device and the one or more transmitters and receivers can include storing, in the one or more storage devices, a set of rules for confirmation in the trading of the financial instruments. The set of rules can be mutually agreed upon by a buy-side party and a sell-side party. The method can include receiving trade messages sent, over the network, between the buy-side party and the sell-side party. At least one trade message can include allocation information from the buy-side party including one or more allocated trades. The method can include validating the trade messages between the buy-side party and the sell-side party, and generating an electronic file including an enriched trade report based on at least the trade messages, the set of rules, and the allocation information. The method can include transmitting, over the network, the electronic file to the buy-side party and the sell-side party.

In one embodiment, receiving the trade messages can include intercepting Financial Information eXchange (FIX) messages. Receiving the trade messages can include intercepting a client order instruction message including an order ID parameter, a client ID parameter, and an order volume parameter. Receiving the trade messages can include intercepting an execution record message including an order ID parameter, an execution ID parameter, an executed volume parameter, and an executed price parameter. Receiving the trade messages can include intercepting an allocation record message including an order id parameter, a fund ID parameter, an allocation volume parameter, and an allocation value parameter.

In one embodiment, storing the set of rules can include storing market charge rules. Generating the electronic file including the enriched trade report can include calculating appropriate market charges for each allocated trade. The method can further include receiving, over the network, the market charge rules from the sell-side party, and receiving, over the network, an approval message corresponding to the market charge rules from the buy-side party.

In one embodiment, storing the set of rules can include storing commission rules. Generating the electronic file including the enriched trade report can include calculating an appropriate commission amount for each allocated trade. The method can further include receiving, over the network, the commission rules from the sell-side party, and receiving, over the network, an approval message corresponding to the commission rules from the buy-side party.

In one embodiment, storing the set of rules can include storing standard settlement instruction rules. Generating the electronic file including the enriched trade report can include generating standard settlement instructions for the buy-side party and the sell-side party for each allocated trade. The method can further include receiving, over the network, the standard settlement instructions rules for the buy-side party and the sell-side party, and transmitting, over the network, a notification message to the buy-side party upon receipt of the standard settlement instruction rules for the sell-side party and to the sell-side party upon receipt of the standard settlement instruction rules for the buy-side party.

In one embodiment, the method can further include storing the electronic file including the enriched trade report, for each allocated trade, for a predetermined period of time.

In another aspect of the disclosed subject matter, a non-transitory computer readable medium containing computer-executable instructions that when executed can cause one or more computer devices to perform a method for managing the trading of financial instruments using a central utility.

### BRIEF DESCRIPTION OF THE DRAWINGS

FIG. 1 is a block diagram of an exemplary system for managing the trading of financial instruments using a central utility in accordance with an embodiment of the disclosed subject matter.

FIG. 2 is a flowchart illustrating a method for managing the trading of financial instruments in accordance with an exemplary embodiment of the disclosed subject matter.

FIG. 3 is a flowchart illustrating a method for managing the trading of financial instruments in accordance with an exemplary embodiment of the disclosed subject matter.

FIG. 4A is the top portion of a screenshot of an exemplary user interface for displaying market charges in accordance with an embodiment of the disclosed subject matter.

FIG. 4B is the bottom portion of the screen shot of FIG. 4A.

FIG. 4C is the top portion of a screenshot of an exemplary user interface for entering market charge rules in accordance with an embodiment of the disclosed subject matter.

FIG. 4D is the bottom portion of the screen shot of FIG. 4C.

FIG. 4E is the top portion of a screen shot of an exemplary user interface for entering commission rules in accordance with an embodiment of the disclosed subject matter.

FIG. 4F is the bottom portion of the screen shot of FIG. 4E.

FIG. 4G is the top portion of a screen shot of an exemplary user interface for entering buy side standard settlement instruction rules in accordance with an embodiment of the disclosed subject matter.

FIG. 4H is the bottom portion of the screen shot of FIG. 4G.

FIG. 4I is the top portion of a screen shot of an exemplary user interface for entering sell side standard settlement instruction in accordance with an embodiment of the disclosed subject matter.

FIG. 4J is the bottom portion of the screen shot of FIG. 4I.

FIG. 5 is a simplified block diagram illustrating block trades.

FIG. 6 is a diagram illustrating the management of trading of financial instruments using a central utility in accordance with an exemplary embodiment of the disclosed subject matter.

FIG. 7 is a diagram illustrating the management of trading of financial instruments using a central utility in accordance with another exemplary embodiment of the disclosed subject matter.

Throughout the drawings, the same reference numerals and characters, unless otherwise stated, are used to denote like features, elements, components or portions of the illustrated embodiments. Moreover, while the disclosed subject matter will now be described in detail with reference to the figures, it is done so in connection with the illustrative embodiments.

### DETAILED DESCRIPTION

The presently disclosed subject matter provides techniques for enabling a centralized enrichment service for client trade allocation and confirmation in the trading of financial instruments (including, but not limited to, equities, options, futures, derivatives, or any other traded financial instrument). The techniques disclosed herein can be used, for example, for trade confirmation without the need for independent derivation and subsequent matching.

Exemplary embodiments of the disclosed subject matter are described below, with reference to the figures, for purposes of illustration, and not limitation.

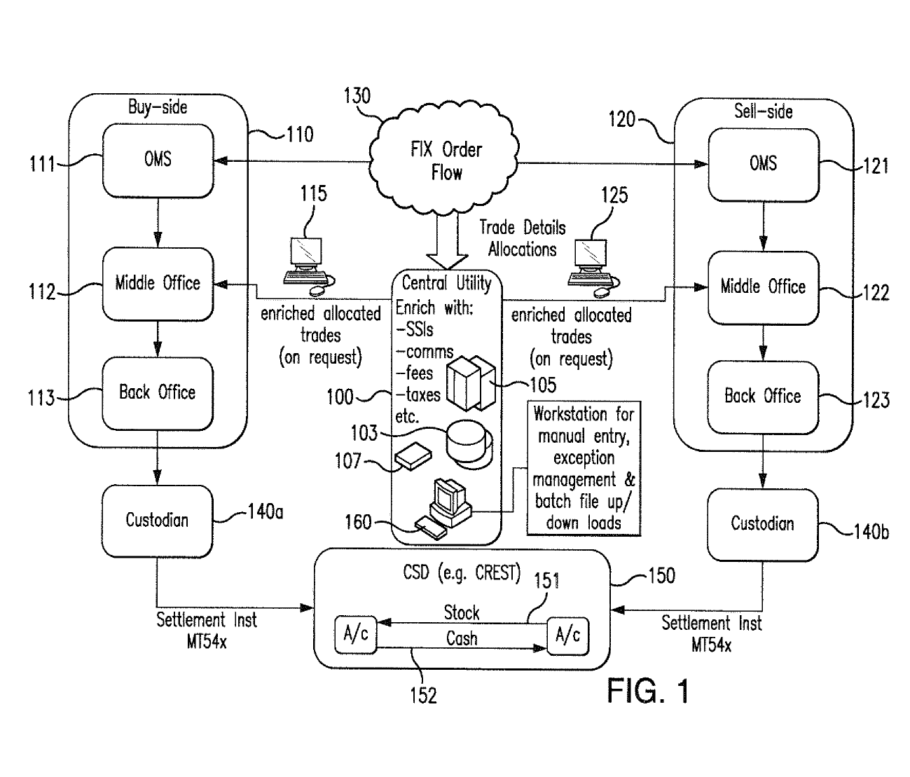

In an exemplary embodiment, with reference to FIG. 1, a system for managing the trading of financial instruments using a central utility 100 can include one or more storage devices 103 having stored therein one or more sets of rules for confirmation in the trading of the financial instruments. A set of rules can be mutually agreed upon by a buy-side party 110 and a sell-side party 120, or otherwise established for the reconciliation of transactions. One or more transmitters and receivers 107 can be communicatively coupled to a computer network. One or more computer processors can be operatively coupled to the one or more storage devices 103 and the one or more transmitters and receivers 107, and can be configured to receive trade messages 130 sent, over the network, between the buy-side party 110 and the sell-side party 120. In connection with the trading of financial instruments requiring allocation, at least one of the trade messages can include allocation information from the buy-side party including one or more allocated trades. The one or more processors associated with the central utility can be configured to receive and validate the trade messages 130 between the buy-side party and the sell-side party and generate an electronic file including an enriched trade report based on at least the trade messages, a set of rules, and the allocation information. The electronic file can be transmitted over the network to the buy-side party 110 and the sell-side party 120.

As embodied herein, the central utility 100 can include, for example, one or more servers 105 connected to a network, such as the internet or an intranet, and which can include one or more computer processors and memories. Alternatively, the central utility 100 can include a stand alone computer, a server cluster, a distributed computing system, a cloud-based computing system, or the like. In an exemplary embodiment, the central utility 100 can include a workstation 160 including a display and input device, such as a keyboard, to enable manual entry, exception management, and batch file uploads and downloads. The memories 103 associated with the central utility 100 can store executable instructions which, when executed by a processor, can implement the techniques disclosed herein. As embodied herein, the memories 103 can include non-transitory computer readable storage media, including, without limitation, random access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), a CD-ROM, DVD, Magnetic disk, or the like. Moreover, as used herein, the term “memory” or “memories” can include one or more databases.

For purposes of illustration, and not limitation, the central utility 100 can be embodied in a conventional server/database product, such as a rack server with support for database applications. For example, in one embodiment, the central utility 100 can include an HP ProLiant DL380 Gen 8 server, which can include two Intel Xeon E5-2690 processors (8-core, with a clock speed of 2.9 GHz), 96 GB RAM, and eight 300 GB storage drives. Additionally or alternatively, the central utility 100 can include an HP ProLiant DL580 G7 Server with four Intel Xeon E7-4870 processors (10-core, with a clock speed of 2.4 GHz, a cache of 30 MB, and a maximum TDP of 130 W), four memory boards, 512 GB RAM, and eight 600 GB storage drives capable of operating at 10,000 RPM. The server of the central utility 100 can run, for example, an operating system such as Solaris 10 for x86 platforms. One of ordinary skill in the art would recognize that a variety of other suitable hardware and software configurations are available, and that the disclosed subject matter is not limited to the exemplary embodiments disclosed herein.

The central utility 100 can include hardware, e.g., transmitters and receivers 107, for communicating via a network with one or more computing devices operated by sell-side parties 120, and for communicating via the network with one or more computing devices operated by buy-side parties 110. The network can be, for example, the internet or a public or private intranet. In an exemplary embodiment, the network can be a dedicated network for the purpose of trading financial instruments. The transmitters and receivers 107 can include, for example, one or more network interface cards adapted to communicate via the network. For example, a single network interface card can be used as both a transmitter and receiver to send data over the network. Additionally or alternatively, the transmitters and receivers 107 can include one or more modems, routers, access points, switches, or the like. In an exemplary embodiment, the central utility 100 can include a dedicated high speed connection, such as a T1 or T3 line, or some other type of fiber-optic connection, through a service provider. For purpose of illustration, communication via the transmitters and receivers 107 over the network can be in accordance with a known protocol, such as Financial Information eXchange (“FIX”). Additionally or alternatively, communication via the transmitters and receivers 107 over the network can be in accordance with the ISO 15000 series of specifications, Swift, or any other suitable message format. In certain embodiments of the disclosed subject matter, the central utility 100 can be protocol agnostic. That is, the central utility 100 need not be driven by any particular message protocol. Rather, the order flow between a sell-side party and a buy-side party can be accomplished in accordance with the disclosed subject matter in any industry standard protocol or in a proprietary protocol. Moreover, the central utility 100 can be agnostic to the particular front, middle, and back end systems implemented by the buy-side 110 and sell-side 120 parties. In accordance with the disclosed subject matter, trade enrichment can occur with any messaging protocol, IT infrastructure, and can provide enrichment beyond SSIs, including, e.g., market charges and fees, commission fees, and values, as described herein.

Buy-side parties 110 can include, but are not limited to, individuals, firms, or other entities who place trade orders (including buy and sell orders), such as an investment manager. The term buy-side party, as disclosed herein, can include systems operated by buy-side entities, including hardware and software systems. For example, an investment manager entity can operate within a “front-office,” “middle-office,” and “back-office” environment. The front-office can include departments of the investment manager entity such as investment banking and trading departments. For example, front-office systems can, but need not, include order management systems (“OMS”) 111 that can facilitate the trading of financial instruments. In particular, for example, the OMS can transmit and receive trade order instructions, for example according to the FIX protocol. While FIG. 1 depicts a front-office system including an OMS for purposes of illustration, the disclosed subject matter is not intended to be limited to such. One of ordinary skill in the art will appreciate that front-office systems can also include other electronic systems for management of work flow, or/or non-electronic systems. That is, for example, the front-office workflow can in certain embodiments be managed manually.

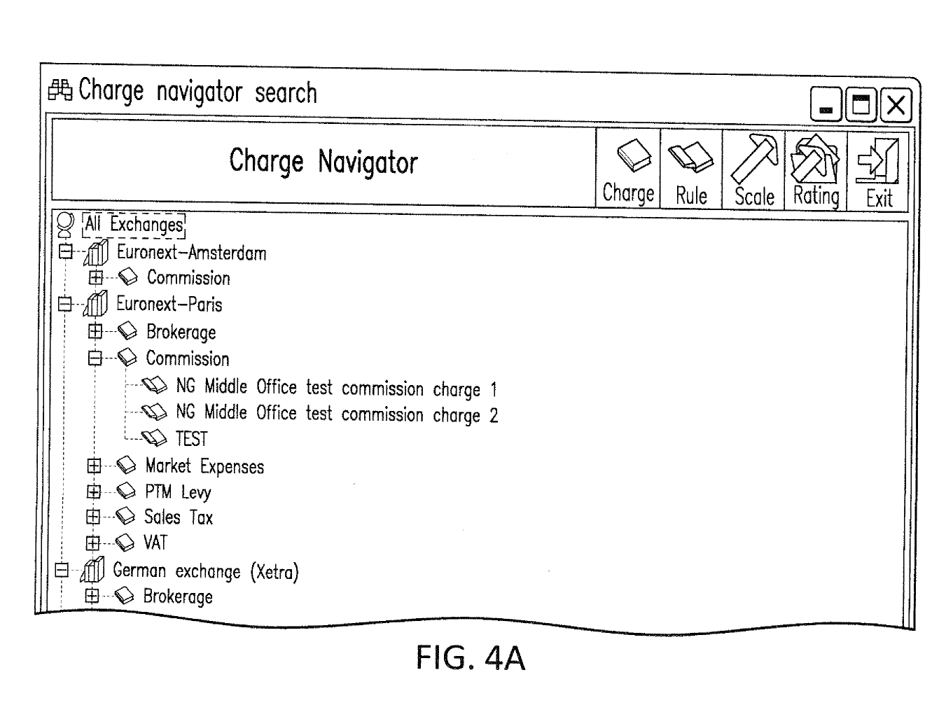

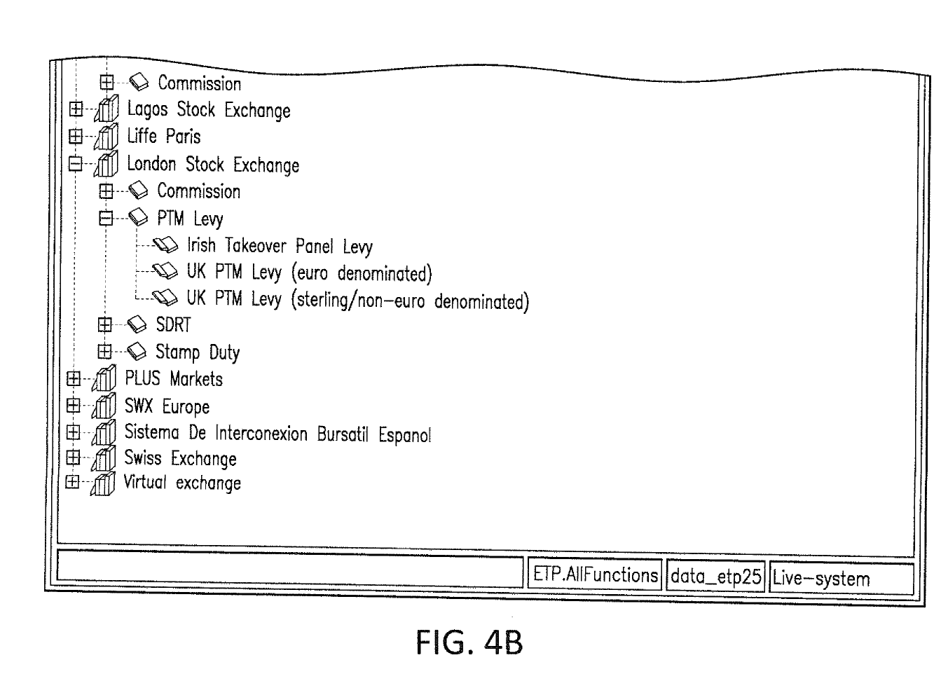

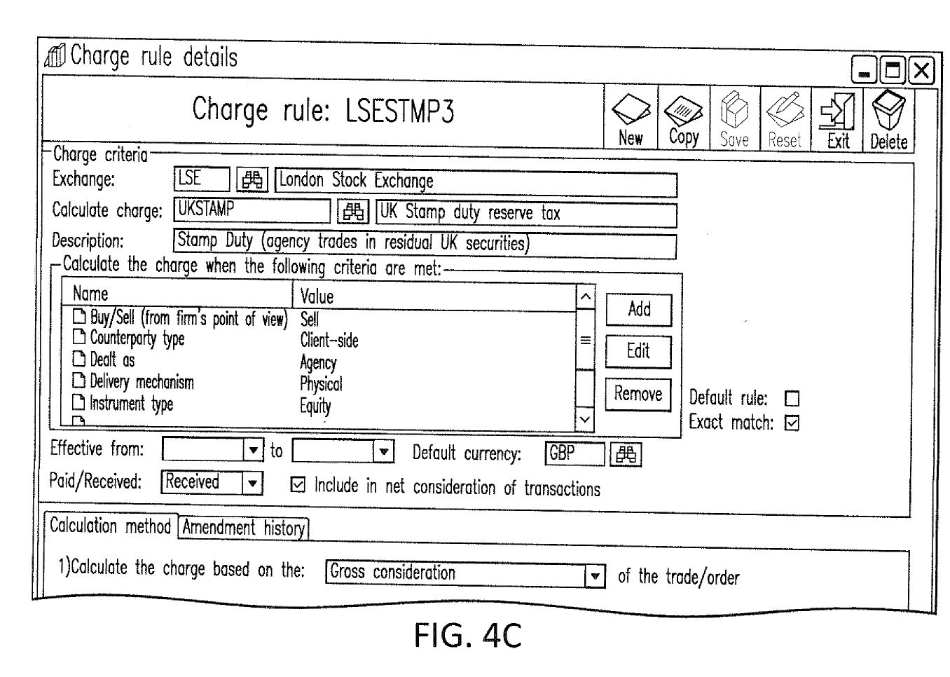

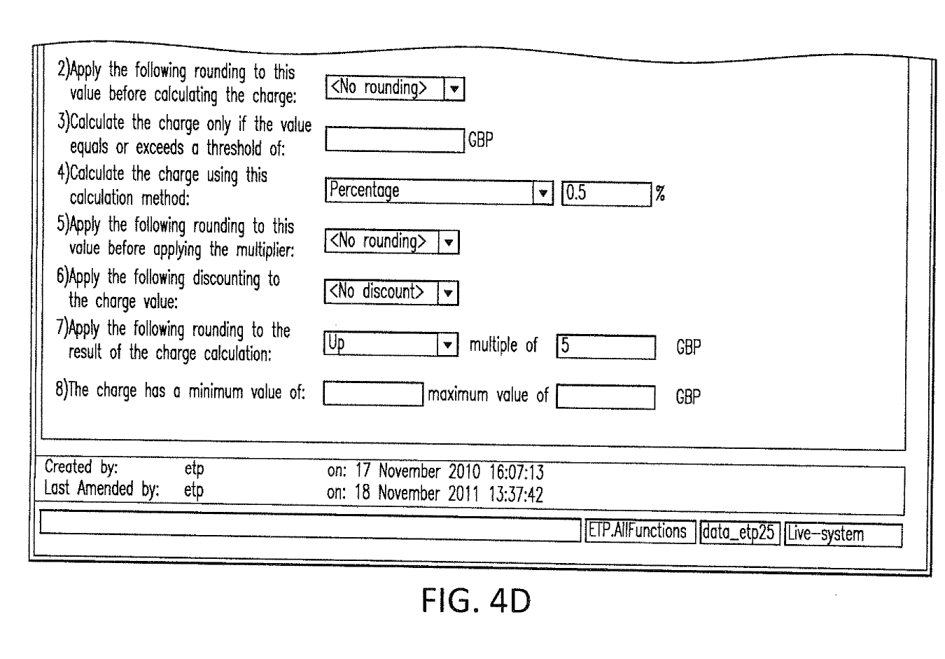

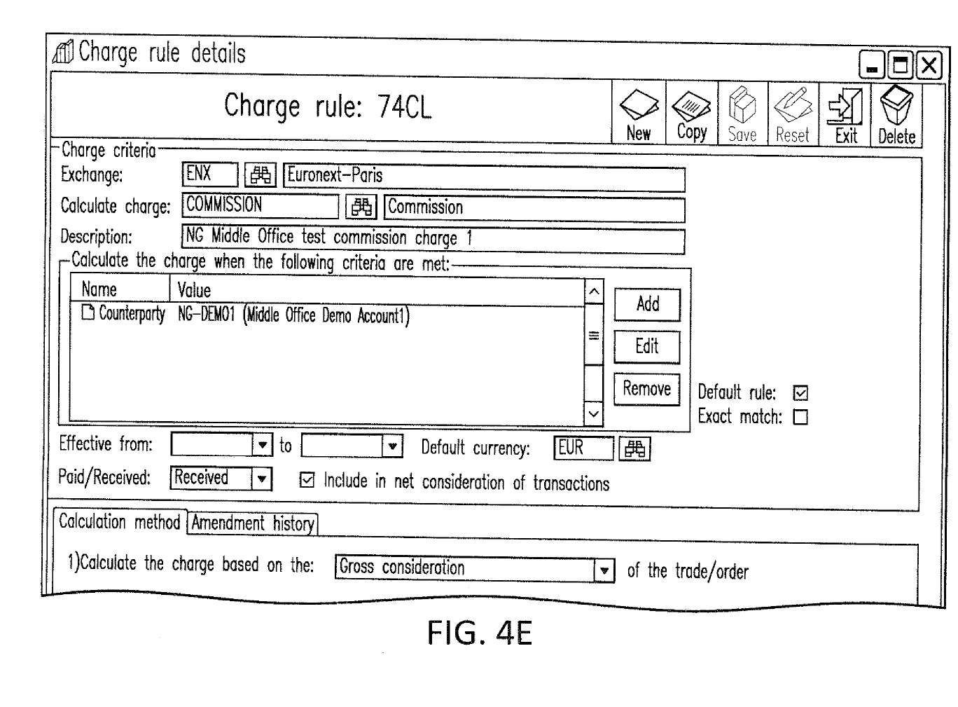

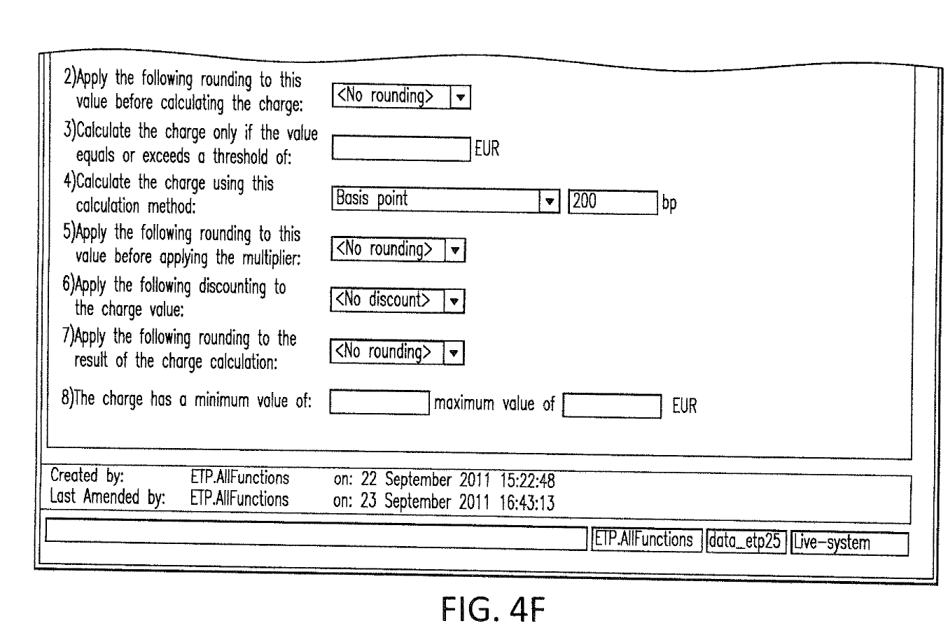

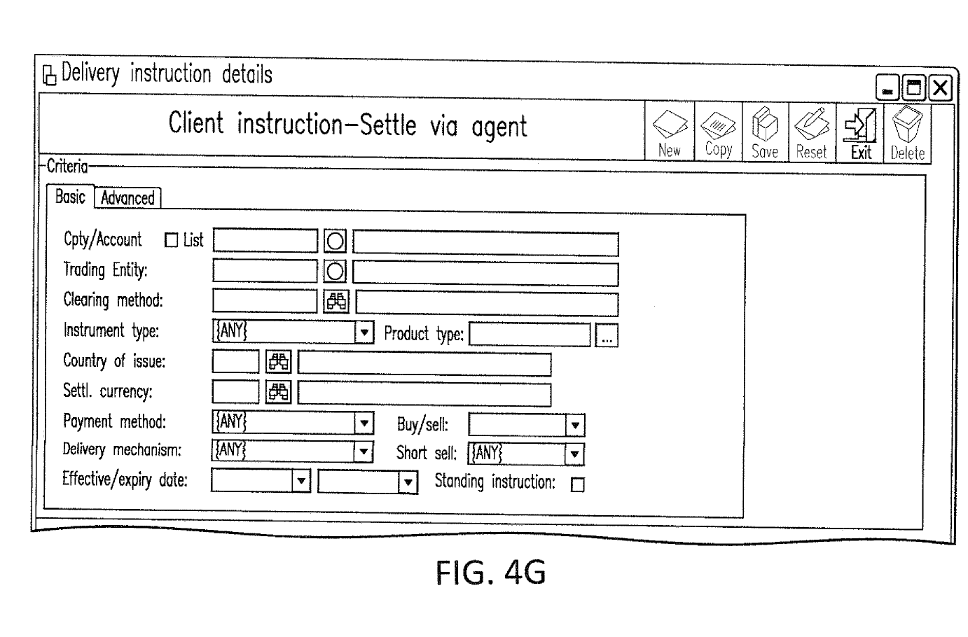

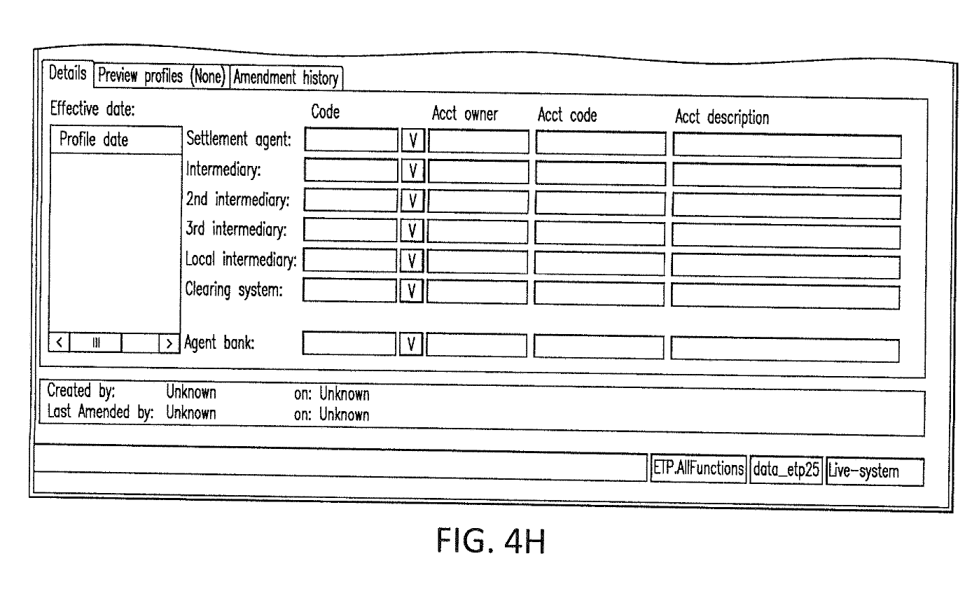

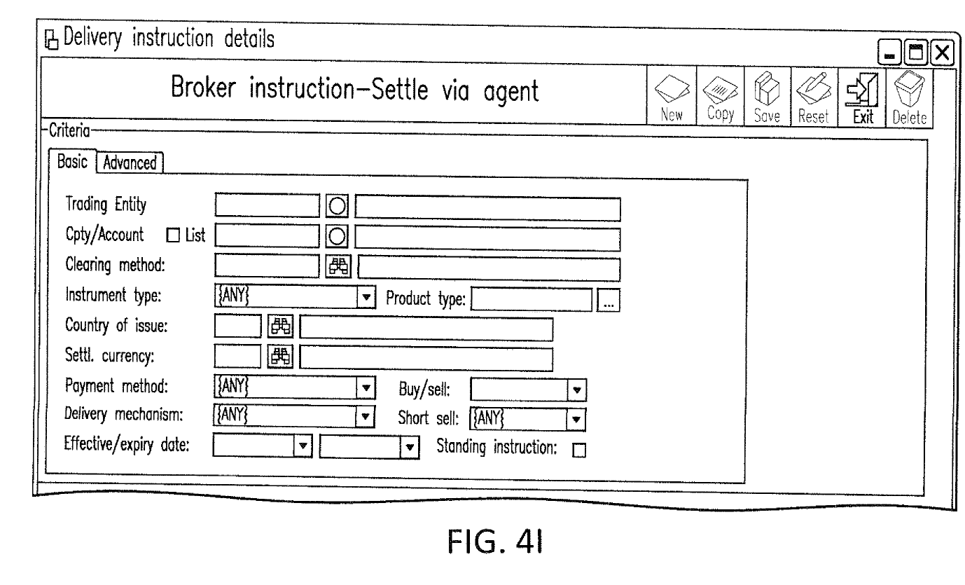

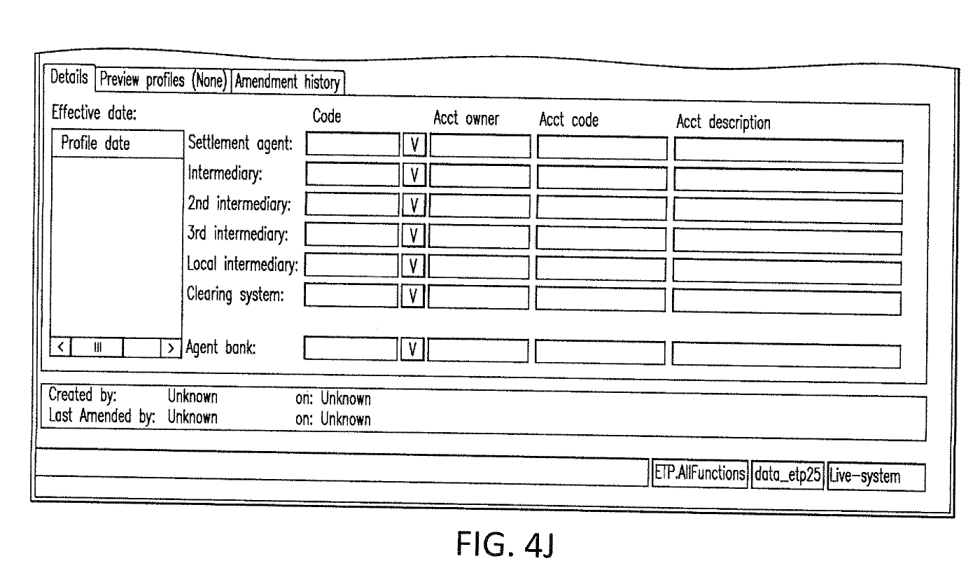

The middle-office 112 can include departments of the buy-side entity that handle, for example, risk management, financial management, and strategy. The middle-office 112 workflow can be built around the transfer of the necessary additional information to drive the settlement process between buy-side 110 and sell-side 120 parties. In accordance with an embodiment of the disclosed subject matter, the middle-office 112 can include systems communicatively coupled to the central utility 100. For example, the middle-office 112 can include one or more workstations 115 configured with functionality in accordance with the disclosed subject matter. The workstations 115 can be desktop computers, adapted to display a desktop user interface, such as that described below with reference to FIGS. 4A-J. For example, the desktop can be provided with an operating system, such as Windows XP, Windows Vista, Windows 7 or the like, suited to run software configured to display the user interface. In this manner, the workstations 115 can receive enriched allocated trades from the central utility 100 as described herein.

The back-office 113 can include departments of the buy-side party 110 that handle operations, which traditionally can include verification of trades and executing the required transfers (e.g., settlement). However, the settlement process need not be performed in the back-office, and can instead be handled by a third party agent or custodian 140a. Each department can operate systems for facilitation and execution of their respective tasks. Such systems can include a number of hardware devices, such as computers, connected via a network, such as an intranet or the Internet.

Sell-side parties 120 can include, but are not limited to, entities such as broker-dealers. The term sell-side party, as disclosed herein, can include systems operated by sell-side entities, including hardware and software systems. In like manner as buy-side parties, sell-side parties 120 can operate within a front-office 121, middle-office 122, and back-office 123 environment. One of ordinary skill in the art will appreciate that the description of such an environment is for purpose of illustration only, and the operations accomplished by the front-office, middle-office and back-office can be accomplished by a single department within an entity, multiple departments within different entities, or multiple departments within a single entity. Accordingly, the disclosed subject matter is not limited to embodiments wherein each function is handled by a separate department.

In this exemplary embodiment, the central utility 100 can be configured to maintain a database, for example in the one or more memories 103 or in one or more other computer readable media storage devices, such as magnetic or optical disks to store data sets including fund details, settlement instructions, agreed-upon market charges, commission rules, and the like. For example, the set of rules can include market charge rules to calculate appropriate market charges for each allocated trade. The receiver 107 can be configured to receive, over the network, the market charge rules from the sell-side party 120 and receive, over the network, an approval message corresponding to the market charge rules from the buy-side party. Upon receipt of the approval message, the market charge rules can be stored in the one or more storage devices. That is, for example, a broker-dealer can be responsible for the set-up of the market charge rules, but the investment manager can approve each rule prior to use.

In like manner, the set of rules can include commission rules to calculate appropriate commission amount for each allocated trade. The receiver 107 can be configured to receive, over the network, the commission rules from the sell-side party 120 and receive, over the network, an approval message corresponding to the commission rules from the buy-side party 110. Upon receipt of the approval message, the commission rules can be stored in the one or more storage devices. That is, for example, a broker-dealer can be responsible for the set-up of the commission rules, but the investment manager can approve each rule prior to use.

Similarly, the database can store account and sub-account data, including the details of client accounts and sub-accounts required to validate an order and allocation. The central utility 100 can be configured to receive data from a broker dealer or other sell-side party 120 to set up and maintain the client account data. Additionally, the database can store SSI details for each client sub-account, and can store Client SSIs received from a buy-side party and Broker SSIs received from a sell-side party. The SSIs can include, for example, instructions for an agent or custodian 140a and/or 140b (collectively 140) to exchange financial instruments (e.g., equities 151) for cash 152 during the settlement process 150. For example, and not limitation, the settlement process 150 can include the use of a central securities depository (“CSD”) or international central securities depository (“ICSD”), such as DTC, CREST, or the like, and can include the use of an securities settlement system to obviate the need for physical exchange of financial instruments. That is, for example, the buy-side party 110 and sell-side party 120 can hold financial instruments in a dematerialized form within an electronic settlement system via a custodian 140. Agents can then affect a transfer and/or payment between the parties within the CSD.

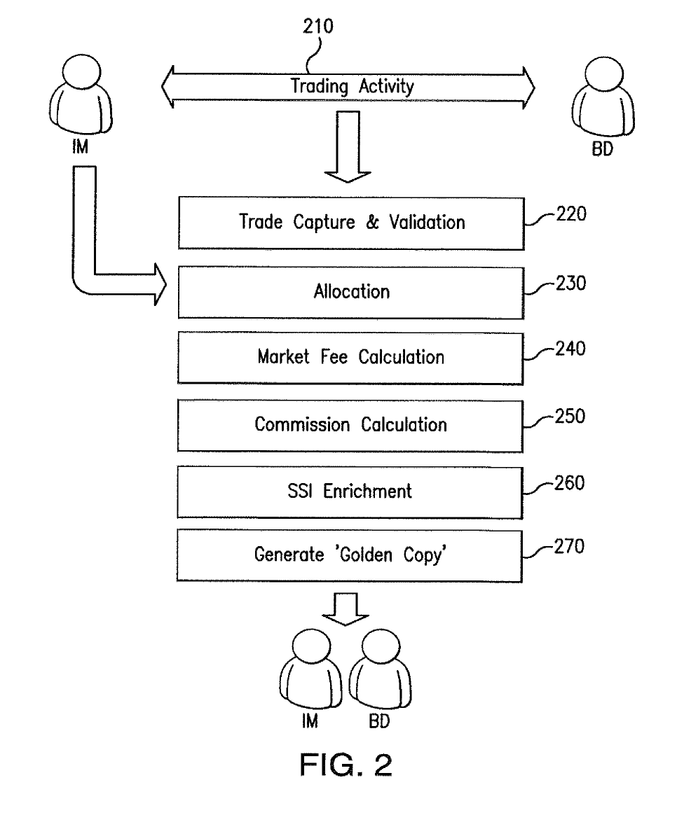

For purposes of illustration and not limitation, an exemplary embodiment of the method disclosed herein will now be described with reference to FIG. 2. In this exemplary embodiment, a method for managing the trading of financial instruments using a central utility can include storing, in the one or more storage devices, a set of rules for confirmation in the trading of the financial instruments. The set of rules can be mutually agreed upon by a buy-side party and a sell-side party. The method can include receiving trade messages 210 sent, over the network, between the buy-side party and the sell-side party. At least one trade message can include allocation information 230 from the buy-side party including one or more allocated trades. The method can include validating 220 the trade messages between the buy-side party and the sell-side party, and generating 270 an electronic file including an enriched trade report (which may also be referred to as a “golden copy”) based on at least the trade messages, the set of rules, and the allocation information. The method can include transmitting, over the network, the electronic file to the buy-side party and the sell-side party.

In this exemplary embodiment, storing the set of rules can include storing market charge rules, commission rules, and standard settlement instruction rules Generating 270 the electronic file including the enriched trade report can include calculating appropriate market charges 240 for each allocated trade, calculating an appropriate commission amount 250 for each allocated trade, and generating standard settlement instructions 350 for the buy-side party and the sell-side party for each allocated trade.

As embodied herein, receiving the trade messages 210 can include intercepting Financial Information eXchange (FIX) messages, or message in any other suitable format. For purpose of example, receiving the trade messages 210 can include intercepting a client order instruction message including an order ID parameter, a client ID parameter, and an order volume parameter. Additionally or alternatively, receiving the trade messages 210 can include intercepting an execution record message including an order ID parameter, an execution ID parameter, an executed volume parameter, and an executed price parameter. Additionally or alternatively, intercepting the trade messages 210 can include intercepting an allocation record message including an order ID parameter, a fund ID parameter, an allocation volume parameter, and an allocation value parameter.

As used herein, receiving trade messages 210 can include electronic interception as well as transmission from the buy-side or sell-side party to the central utility. For example, where electronic messages are transmitted between the buy-side and sell-side parties, the central utility can be configured such that the electronic messages are passed through the central utility as a proxy and the central utility can be configured to record and/or capture the information in the messages exchanged therethrough. Alternatively, the sell-side and buy-side parties can communicate directly, and one or both parties can provide the central utility with the messages exchanged, either electronically or exchanged by other means, either contemporaneously or at a later time.

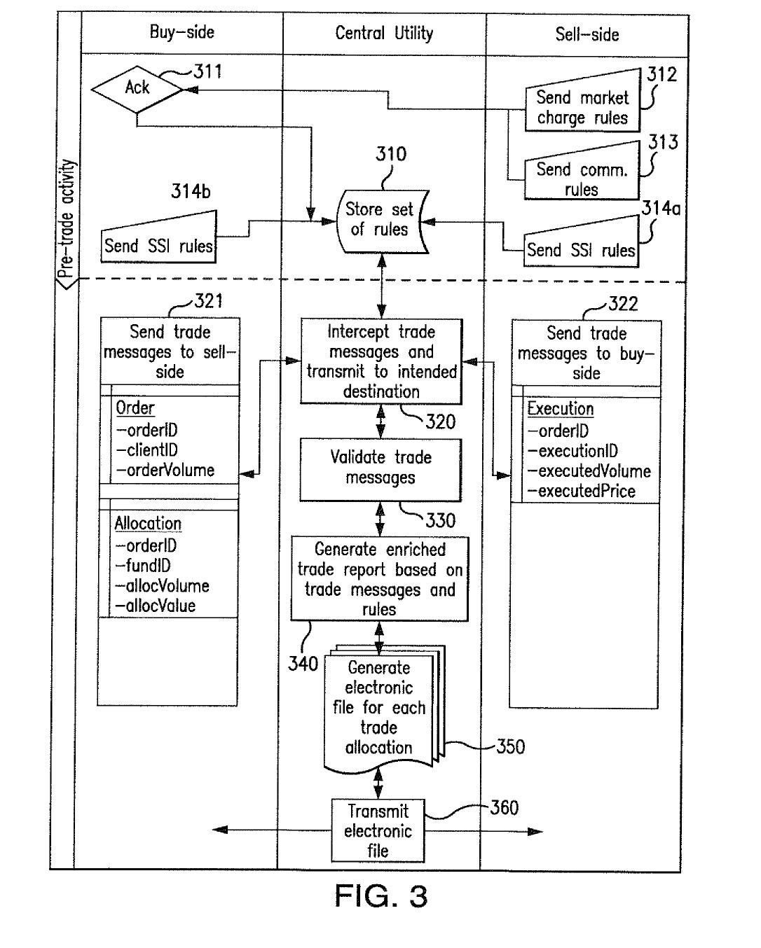

Description will now be made to an exemplary embodiment of the method disclosed herein, with reference to FIG. 3, for purpose of illustration and not limitation. In this exemplary embodiment, the method can include first storing 310 a set of rules for confirmation in the trading of the financial instruments. The set of rules can be mutually agreed upon by a buy-side party and a sell-side party. For example, the sell-side party can send market charge rules 312 and send commission rules 313 to the central utility, which can transmit them for review by the buy-side party. The buy side party can then acknowledge 311 the rules, at which time they can be stored 310. The sell-side party can send SSI rules 314a to the central utility, which can then store 310 the sell-side party SSI rules. In like manner, the buy-side party can also send SSI rules 314b to the central utility, at which time they can be stored.

The storage of rules as described above can be accomplished through central data administration in connection with the central utility. That is, for example, the central utility can allow the buy-side and sell-side parties to control the rules that drive the enrichment process, as described herein. Each buy-side party can view the market charge and commission rules that have been entered by the sell-side party, and can approve or reject 311 the rules. By approving a rule, the rule can become active in the central utility. For purpose of illustration, such techniques can be accomplished via one or more user interfaces such as those depicted in FIG. 4, accessible to each party via the network. For example, with reference to FIGS. 4a and b, the central utility can provide industry agreed market fee rules. Such rules can be maintained by the central utility, but can be viewed by all participants via the exemplary user interface depicted in FIGS. 4a and b.

The central utility can provide sell-side parties with an interface to maintain commission rules on a per-relationship basis. For example in one embodiment, with reference to FIGS. 4c and d, any commission rule additions or updates can take effect, and the buy-side party is notified. The central utility can provide buy-side parties with the ability to maintain account details. For example, with reference to FIGS. 4e and f, a user interface can be provided to facilitate account additions or updates, which can take effect, and can be notified to the sell-side parties who have a relationship with the buy-side party entering the additions or updates. Additionally, the central utility can provide buy-side parties with the ability to maintain account SSI details. For example, with reference to FIGS. 4g and h, any account SSI additions or updates can take effect, and the sell-side parties who have a relationship with the buy-side party entering the additions or updates can be notified. In like manner, and with reference to FIGS. 4i and j, the central utility can provide sell-side parties with the ability to maintain SSI details. Any sell-side party SSI additions or updates can likewise take effect, and buy-side parties who have a relationship with the sell-side party entering the additions or updates can be notified. As embodied herein, the central utility can further provide participants with the ability to view and maintain corresponding active relationships. New relationships can be established through “inviting” a counterparty. Upon acceptance of an invite, the relationship can be established.

Again with reference to FIG. 3, upon storage of the desired rules, the method can include intercepting 310, at the central utility, trade messages. For example, the central utility can transparently (e.g., without interruption or change of the transmission) intercept FIX messages between the buy-side and sell-side parties. In one embodiment, for example, both the sell-side and buy-side parties can be communicatively coupled to the central utility, e.g., via the network, so as to transmit and receive data from the one or more receivers/transmitters of the central utility. In this manner, the central utility can act as a proxy, and can receive messages sent from the sell-side party 321 and transmit them to the buy-side party, and vice versa 322. Alternatively, in certain embodiments, messages can be transmitted directly between the sell-side and buy-side party, and additionally transmitted in parallel to the central utility. Alternatively, messages sent between the sell-side and buy-side party can be stored, e.g., in a database, and later transmitted to, or accessed by, the central utility.

As described above, the trade messages can include a client order instruction sent from the buy-side party 321, an execution record sent from the sell-side party 322, and an allocation entry sent from the buy-side party 321. The central utility can receive each of the three information inputs independently of one another. Each message received can be validated 330 for certain information, and if an error is detected, the central utility can flag the error. Moreover, the transmitting party can resend the information as an amendment, or send a cancellation. In certain embodiments, the central utility need not receive the messages in any particular order.

Validation 330 by the central utility can include, for example, ensuring that both parties have a common view of the instrument traded, quantity traded, average price, and commission rate. Validation 330 can include, for example, using the set of rules stored in the central utility and the information supplied by each party independently in the trade messages. For purposes of example, in connection with trading in cash equity markets, a buy-side party can send an order (e.g., a New Order Single (“NOS”)), and the central utility can validate the instrument and broker. Moreover, the central utility can validate accounts if pre-allocation details are supplied as part of the order. The sell-side party can then send an execution (e.g., an Execution Report (“ER”)), and the central utility can validate the instrument and order quantity. The buy-side party can then send allocations (e.g., Allocation Instructions (“AI”)), and the central utility can validate that the quantity and price is consistent with the execution.

Furthermore, for illustration, validation 330 can include validating that the buy-side and sell-side have a relationship defined within the central utility, and that any static data for the instrument required for calculating charges is provided or known (including, e.g., country of registration or the like). If accounts are supplied with the order, validation 330 can include verification that all accounts have been defined in the central utility if not already defined in the order. Upon receipt of allocation messages, the central utility can further validate that the quantity and price based on the allocation message comports the sum of fills.

After an order has been received, one or more executions have been received with the same order ID where the sum of the execution quantities is equal to or less than the order volume, and one or more allocations have been received with the same order ID where the sum of the allocations is equal to the sum of the execution quantities, the central utility can “enrich” each allocation and generate an electronic file 350 including a generated enriched trade report 340 based on at least the trade messages, the set of rules, and the allocation information. That is, for example, for each allocation, the central utility can apply the appropriate market charges and commission fees as set forth in the stored market charge rules and commission rules. Additionally, the central utility can apply the appropriate SSIs, as set forth in the stored SSI rules, to each allocation.

The generation 340 of the enriched trade report (or “golden copy”) can be a single trade report for each allocation in a standard file format. For purposes of illustration and not limitation, the trade report can be generated in extensible markup languages such as, for example, XML, or a fixed field file format. Each trade report can include each of the applicable charges and commission values, and the SSIs. The trade report embodied in an electronic file can be transmitted 360 to both the sell-side and buy-side parties. The delivery of the trade report can provide both parties with settle-able trades, without the overhead of a conventional matching process. The techniques disclosed herein can provide efficient delivery of the trade report by undertaking economic calculations and business enrichment on behalf of both parties to a trade using the agreed upon terms of engagement (e.g., the stored rules). By using the pre-agreed rules, there is no requirement for the buy-side party to check or validate each individual allocated trade. Rather, the process can be driven from the original order instruction, with the buy-side party needing only to supply sub-account allocations and receive a final settle-able trade. The disclosed subject matter thereby provides increased efficiency and decreased overhead in trade processing.

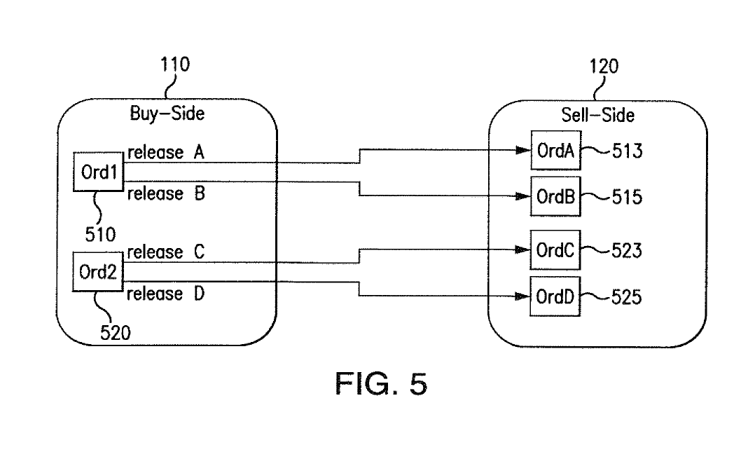

For purpose of illustration and not limitation, as embodied herein, trades can include “block trades” (e.g., an order placed regarding a large volume of securities). Block trades are often executed on behalf of a plurality of sub-funds, and thus the block trades must be allocated across the sub-accounts. With reference to FIG. 5, block trading can include the release of an order from the buy-side 110, which the sell-side 120 can receive as a new order single. Within each block order, for example, the buy-side 110 can release a first order (“Ord1”) 510 with buy-side blocks A and B 510 which can be received by the sell-side 120 as sell-side blocks order A 513 and order B 515. Likewise, buy-side 110 can order release buy-side block C and D 520, which can be received by the sell-side 120 as sell-side blocks order C 523 and order D 525.

In connection with certain conventional techniques allocation of block trades, the buy-side party can receive the sub-account allocation information from the buy-side party via, e.g., telephone, facsimile, email, or FIX messages. While the use of FIX can increase the efficiency of sub-account allocation by the sell-side party, separate confirmation can be required. That is, for example, for each allocation, the sell-side party can calculate the market charges and fees, and is typically responsible for the collection and payment of the fees to appropriate authorities. As disclosed herein, the central utility 100 can provide for efficient trade allocation and confirmation by, among other things, undertaking economic calculations and business enrichment on behalf of both the buy-side party and the sell-side party using pre-agreed rules. That is, for purposes of illustration and not limitation, the central utility 100 can provide settle-able trades without the need for the buy-side party to validate each individual allocated trade, separate confirmation, and the calculation of market charges, fees, and generation of settlement instructions for each allocated trade by the sell-side party.

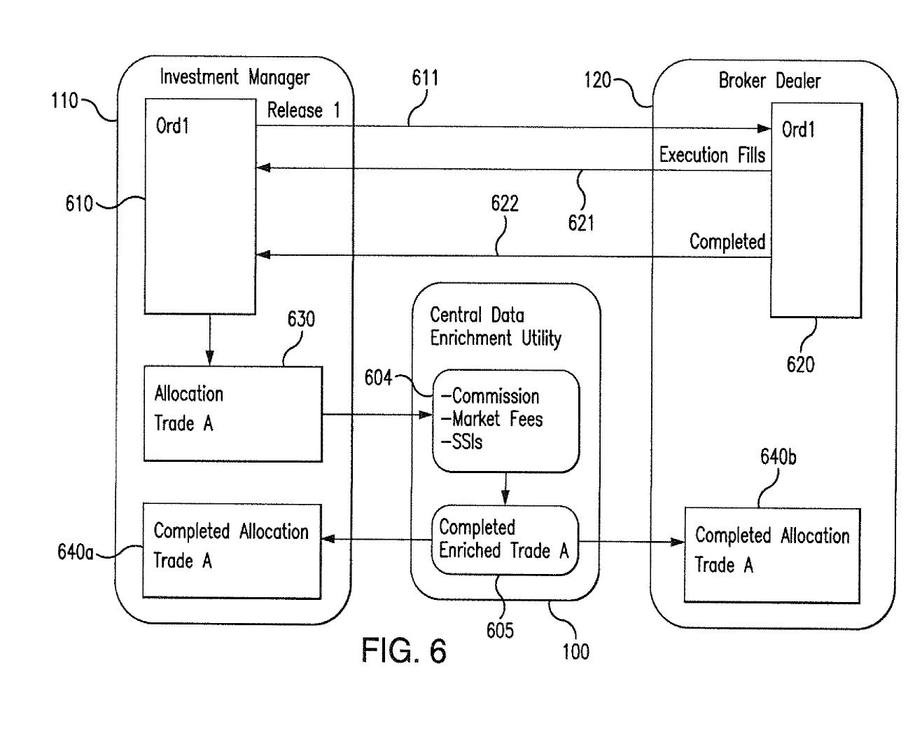

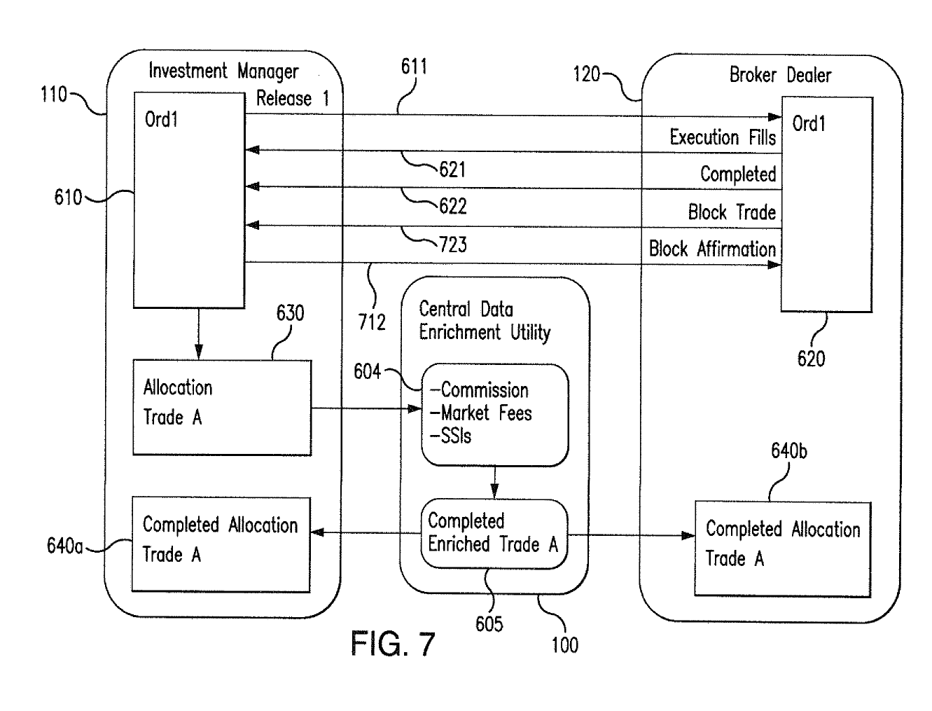

For purposes of illustration and not limitation, additional embodiments will now be described in detail, with reference to FIG. 6 and FIG. 7. In one embodiment, and with reference to FIG. 6, the buy-side 110 and sell-side 120 parties can engage in the trading of a financial instrument. For example, the order flow for a trade can include the following: the buy-side party 110 can release order details 611 for a first order (“Ord 1”) 610 to the sell-side party 120. The released order details 611 can include, for example, broker information, account information, and the like. Upon receipt, the sell-side party 120 can send an acknowledgement (not shown) back to the buy-side party 100 indicating that the order has been received. The sell-side party 120 can then fill the order (“Ord 1”) 620, and transmit execution fill messages 621 to the buy-side party 110. For example, the sell-side party 120 can send an execution message indicating that the order has been partially or completely filled. Upon completion of order execution, the sell-side party 120 can send a message indicating that the order has been completed 622. As depicted in FIG. 6, the order flow can occur directly between the buy-side party 110 and the sell-side party 120. However, in certain embodiments, the order flow can alternatively be passed through the central utility 100, such that the central utility can intercept the trade messages, and optionally validate and enrich the trade messages.

Upon receipt of a message from the sell-side party 120 indicating execution of the order has been completed, the buy-side party 110 can transmit allocation information 630 to the central utility 100. The central utility 100 can process the allocation information 630 using, for example, one or more modules 604 suited to enrich the trade information with the commission rules, market charge rules, and/or SSI rules stored in one or more databases. The central utility can generate an enriched trade report (“golden copy”), e.g., using one or more modules 605, and the central utility can transmit the enriched trade report to both the buy-side party 110 and the sell-side party 120. The enriched trade report can provide enriched allocated trades, without the need for conventional or centralized matching. That is, the disclosed subject matter can provide settle-able enriched bilateral trades with completed allocation information 640a and 640b without matching.

For purposes of illustration and not limitation, and with reference to FIG. 7, the order 610 of the buy-side party 110 can be a block order, as described above. In like manner to FIG. 6, the buy-side party 110 can send order details 611 for a first block order (“Ord 1”) 610, which can optionally include allocation information, to the sell-side party 120. The sell-side party 120 can then fill the order (“Ord 1”) 620, and transmit execution fill messages 621 to the buy-side party 110. In connection with block trades, which can be large and often filled from a plurality of sources, the sell-side party 120 can send execution messages indicating that the order has been partially filled for each action taken in an effort to fill the order, and can send a message indicating that the order has been completed 622. After completion, the sell-side party 120 can transmit to the buy-side party 110 a message 723 including information about the block trade. The buy-side party 110 can send an affirmation 712 in response to the block trade message 732.

The buy-side party 110 can transmit allocation information 630 to the central utility 100. The central utility 100 can process the allocation information 630, generate an enriched trade report, and transmit the enriched trade report to the buy-side and sell-side parties, as described above.

As described above in connection with certain embodiments, certain components, e.g., central utility 100, buy-side 110, sell-side 120 can include a computer or computers, processor, network, mobile device, cluster, or other hardware to perform various functions. Moreover, certain elements of the disclosed subject matter can be embodied in computer readable code which can be stored on computer readable media and which when executed can cause a processor to perform certain functions described herein. In these embodiments, the computer and/or other hardware play a significant role in permitting the system and method for the trading of financial instruments. For example, the presence of the computers, processors, memory, storage, and networking hardware provides the ability to trade financial instruments in a more efficient manner, without the overheard required by conventional independent matching. Moreover, the generation and transmission of the enriched trade report, in the format of an electronic file, cannot be accomplished with pen or paper, as enrichment of each allocation requires the processing of electronic messages with rules stored in a database.

Additionally, as described above in connection with certain embodiments, certain components can communicate with certain other components, for example via a network, e.g., the interne. To the extent not expressly stated above, the disclosed subject matter is intended to encompass both sides of each transaction, including transmitting and receiving. One of ordinary skill in the art will readily understand that with regard to the features described above, if one component transmits, sends, or otherwise makes available to another component, the other component will receive or acquire, whether expressly stated or not.

The presently disclosed subject matter is not to be limited in scope by the specific embodiments herein. Indeed, various modifications of the disclosed subject matter in addition to those described herein will become apparent to those skilled in the art from the foregoing description and the accompanying figures. Such modifications are intended to fall within the scope of the appended claims.

1. A system for managing the trading of financial instruments using a central utility, comprising:
one or more storage devices having stored therein a set of rules for confirmation in the trading of financial instruments, the set of rules mutually agreed upon by a buy-side party and a sell-side party;
one or more transmitters and receivers communicatively coupled to a network; and
one or more processors operatively coupled to the one or more storage devices and the one or more transmitters and receivers, the one or more processors configured to:
receive trade messages sent over the network between the buy-side party and the sell-side party, wherein at least one trade message includes allocation information from the buy-side party including one or more allocated trades;
validate the trade messages between the buy-side party and the sell-side party;
generate an electronic file including an enriched trade report based on at least the trade messages, the set of rules, and the allocation information; and
transmit, over the network, the electronic file including the enriched trade report to at least one of the buy-side party and the sell-side party.

2. The system of claim 1, wherein the central utility includes one or more of a server, a cluster of servers, a distributed computing system, and a cloud based computing system.

3. The system of claim 1, wherein the one or more storage devices include one or more of memory devices, databases, and computer readable media.

4. The system of claim 1, wherein the one or more transmitters and receivers include one or more network interface cards adapted to communicate via the network.

5. The system of claim 1, wherein the trade messages include Financial Information eXchange (FIX) messages.

6. The system of claim 1, wherein the trade messages include one or more of a client order instruction message including an order ID parameter, a client ID parameter, and an order volume parameter.

7. The system of claim 1, wherein the trade messages include an execution record message including an order ID parameter, an execution ID parameter, an executed volume parameter, and an executed price parameter.

8. The system of claim 1, wherein the trade messages include an allocation record message including an order ID parameter, a fund ID parameter, an allocation volume parameter, and an allocation value parameter.

9. The system of claim 1, wherein the set of rules includes market charge rules to calculate appropriate market charges for each allocated trade, and wherein the enriched trade report included in the generated electronic file includes the appropriate market charges.

10. The system of claim 9, wherein the receiver is further configured to receive, over the network, the market charge rules from the sell-side party and receive, over the network, an approval message corresponding to the market charge rules from the buy-side party, whereby upon receipt of the approval message the market charge rules are stored in the one or more storage devices.

11. The system of claim 1, wherein the set of rules includes commission rules to calculate appropriate commission amount for each allocated trade, and wherein the enriched trade report included in the generated electronic file includes the appropriate commission amount.

12. The system of claim 11, wherein the receiver is further configured to receive, over the network, the commission rules from the sell-side party and receive, over the network, an approval message corresponding to the commission rules from the buy-side party, whereby upon receipt of the approval message the commission rules are stored in the one or more storage devices.

13. The system of claim 1, wherein the set of rules includes standard settlement instruction rules to generate standard settlement instructions for the buy-side party and the sell-side party for each allocated trade, and wherein the enriched trade report included in the generated electronic file includes the standard settlement instructions for the buy-side party and the sell-side party.

14. The system of claim 13, wherein the receiver is further configured to receive, over the network, the standard settlement instructions rules for the buy-side party and the sell-side party, and wherein the transmitter is further configured to transmit a notification message to the buy-side party upon receipt of the standard settlement instruction rules for the sell-side party and transmit a notification message to the sell-side party upon receipt of the standard settlement instruction rules for the buy-side party.

15. The system of claim 1, wherein the one or more storage devices is further configured to store the electronic file including the enriched trade report, for each allocated trade, for a predetermined period of time.

16. A method for managing the trading of financial instruments using a central utility including one or more storage devices, one or more transmitters and receivers communicatively coupled to a network, and one or more processors operatively coupled to the one or more storage devices and the one or more transmitters and receivers, comprising:
storing, in the one or more storage devices, a set of rules for confirmation in the trading of financial instruments, the set of rules mutually agreed upon by a buy-side party and a sell-side party;
receiving trade messages sent, over the network, between the buy-side party and the sell-side party, wherein at least one trade message includes allocation information from the buy-side party including one or more allocated trades;
validating the trade messages between the buy-side party and the sell-side party;
generating an electronic file including an enriched trade report based on at least the trade messages, the set of rules, and the allocation information; and
transmitting, over the network, the electronic file including the enriched trade report to at least one of the buy-side party and the sell-side party.

17. The method of claim 16, wherein receiving the trade messages includes intercepting Financial Information eXchange (FIX) messages.

18. The method of claim 16, wherein receiving the trade messages includes intercepting a client order instruction message including one or more of an order ID parameter, a client ID parameter, and an order volume parameter.

19. The method of claim 16, wherein receiving the trade messages includes intercepting an execution record message including an order ID parameter, an execution ID parameter, an executed volume parameter, and an executed price parameter.

20. The method of claim 16, wherein receiving the trade messages includes intercepting an allocation record message including an order ID parameter, a fund ID parameter, an allocation volume parameter, and an allocation value parameter.

21. The method of claim 16, wherein storing the set of rules includes storing market charge rules, and wherein generating the electronic file including the enriched trade report includes calculating appropriate market charges for each allocated trade.

22. The method of claim 21, further comprising:
receiving, over the network, the market charge rules from the sell-side party; and
receiving, over the network, an approval message corresponding to the market charge rules from the buy-side party.

23. The method of claim 16, wherein storing the set of rules includes storing commission rules, and wherein generating the electronic file including the enriched trade report includes calculating an appropriate commission amount for each allocated trade.

24. The method of claim 23, further comprising:
receiving, over the network, the commission rules from the sell-side party; and
receiving, over the network, an approval message corresponding to the commission rules from the buy-side party.

25. The method of claim 16, wherein storing the set of rules includes storing standard settlement instruction rules, and wherein generating the electronic file including the enriched trade report includes generating standard settlement instructions for the buy-side party and the sell-side party for each allocated trade.

26. The method of claim 25, further comprising:
receiving, over the network, the standard settlement instructions rules for the buy-side party and the sell-side party; and
transmitting, over the network, a notification message to the buy-side party upon receipt of the standard settlement instruction rules for the sell-side party and to the sell-side party upon receipt of the standard settlement instruction rules for the buy-side party.

27. The method of claim 16, further comprising:
storing the electronic file including the enriched trade report, for each allocated trade, for a predetermined period of time.

28. A non-transitory computer readable medium containing computer-executable instructions that when executed cause one or more computer devices to perform a method for managing the trading of financial instruments using a central utility, comprising:
storing, in one or more storage devices, a set of rules for confirmation in the trading of financial instruments, the set of rules mutually agreed upon by a buy-side party and a sell-side party;
receiving trade messages sent, over a network, between the buy-side party and the sell-side party, wherein at least one trade message includes allocation information from the buy-side party including one or more allocated trades;
validating the trade messages between the buy-side party and the sell-side party;
generating an electronic file including an enriched trade report based on at least the trade messages, the set of rules, and the allocation information; and
transmitting, over the network, the electronic file including the enriched trade report to at least one of the buy-side party and the sell-side party.

29. The non-transitory computer-readable medium of claim 28, wherein receiving the trade messages includes intercepting Financial Information eXchange (FIX) messages.

30. The non-transitory computer-readable medium of claim 28, wherein receiving the trade messages includes intercepting a client order instruction message including one or more of an order ID parameter, a client ID parameter, and an order volume parameter.

31. The non-transitory computer-readable medium of claim 28, wherein receiving the trade messages includes intercepting an execution record message including an order ID parameter, an execution ID parameter, an executed volume parameter, and an executed price parameter.

32. The non-transitory computer-readable medium of claim 28, wherein receiving the trade messages includes intercepting an allocation record message including an order ID parameter, a fund ID parameter, an allocation volume parameter, and an allocation value parameter.

33. The non-transitory computer-readable medium of claim 28, wherein storing the set of rules includes storing market charge rules, and wherein generating the electronic file including the enriched trade report includes calculating appropriate market charges for each allocated trade.

34. The non-transitory computer-readable medium of claim 33, further comprising:
receiving, over the network, the market charge rules from the sell-side party; and
receiving, over the network, an approval message corresponding to the market charge rules from the buy-side party.

35. The non-transitory computer-readable medium of claim 28, wherein storing the set of rules includes storing commission rules, and wherein generating the electronic file including the enriched trade report includes calculating an appropriate commission amount for each allocated trade.

36. The non-transitory computer-readable medium of claim 35, further comprising:
receiving, over the network, the commission rules from the sell-side party; and
receiving, over the network, an approval message corresponding to the commission rules from the buy-side party.

37. The non-transitory computer-readable medium of claim 28, wherein storing the set of rules includes storing standard settlement instruction rules, and wherein generating the electronic file including the enriched trade report includes generating standard settlement instructions for the buy-side party and the sell-side party for each allocated trade.

38. The non-transitory computer-readable medium of claim 37, further comprising:
receiving, over the network, the standard settlement instructions rules for the buy-side party and the sell-side party; and
transmitting, over the network, a notification message to the buy-side party upon receipt of the standard settlement instruction rules for the sell-side party and to the sell-side party upon receipt of the standard settlement instruction rules for the buy-side party.

39. The non-transitory computer-readable medium of claim 28, further comprising:
storing the electronic file including the enriched trade report, for each allocated trade, for a predetermined period of time.
